(19) United States
(12) Patent Application Publication
(10) Pub. No.: US 2018/0357977 A1
(43) Pub. Date: Dec. 13, 2018

(54) SYSTEM AND METHOD FOR AUGMENTED REALITY INTERFACE TO MOBILE DEVICES

(71) Applicant: Jeri J. Ellsworth, San Martin, CA (US)

(72) Inventors: Jeri J. Ellsworth, San Jose, CA (US); Elizabeth A. Richard, El Granada, CA (US); Jason Cerundolo, Santa Clara, CA (US); Jamie Gennis, San Jose, CA (US)

(73) Assignee: CastAR, Inc., Palo Alto, CA (US)

(21) Appl. No.: 16/000,780

(22) Filed: Jun. 5, 2018

Related U.S. Application Data
(60) Provisional application No. 62/516,435, filed on Jun. 7, 2017.

(51) Int. Cl. G09G 5/00; G02B 27/01; G02C 11/00

(52) U.S. Cl. CPC G09G 5/006; G06T 19/006; G02C 11/10; G02B 27/0172

(57) ABSTRACT

A system and method is presented for high speed data transfer between a mobile computing device and a head mounted virtual or augmented reality display device.

This application claims the benefits of U.S. provisional patent application Ser. No. 62/516,435 filed Jun. 7, 2017, which is incorporated in its entirety.

### RELATED APPLICATIONS

US 2014/0340424 Ellsworth

### OTHER PUBLICATIONS

M. Li and A. I. Mourikis, “3-D motion estimation and online temporal calibration for camera-IMU systems,” 2013 IEEE International Conference on Robotics and Automation, Karlsruhe, 2013, pp. 5709-5716.

### FIELD OF THE INVENTION

The current invention relates to the art of augmented reality devices and the electronic means to transfer image and other data from the real world to mobile devices.

### DESCRIPTION OF THE RELATED ART

Many devices are made to address the opportunities in the arts of virtual and augmented reality (VR and AR) that require a computational device such as a desktop computer to be interfaced to a head mounted display (HMD). As mobile devices have become more powerful, the desire has mounted to “break the cord” that keeps VR and AR limited to a small fixed area. AR on smartphones is now well known as it supports applications such as Pokémon GO. Designers of smartphones are adding external video interface capability such as DisplayPort over USB-C, USB-3.0 and other high speed interfaces, in order to be able to support connections to coming head mounted displays (such as glasses) that will facilitate a next generation of mobile VR and AR. However, in order to gather image and other data from the real world environment of the user, a problem currently exists in having the needed bandwidth going into the mobile computing device, or smartphone, in order to facilitate such activities as simultaneous location and mapping (known in the art as SLAM), object recognition and tracking by computer vision and gesture input etc. Whereas some VR and AR implementations use the built-in cameras of mobile devices with internal high speed data transfer, a problem often exists when the camera or cameras are located externally in the head mounted display, or elsewhere, and data must be transferred over an external interface.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Increasingly, there are systems that require more and more image transfer streams, yet the constraints of system bandwidth grow at rates that may not always keep pace with the demands of these image transfer streams. An example of this type of system is an AR or VR system that must pass high-resolution display image streams for both eyes, and also retrieve information from one or more camera image streams, and/or sensors such as inertial measurement units, to provide feedback to the display image generation process.

In such a system, the viewing position of the head and perhaps even eyes must be determined relative to the physical world, as well as information about any objects of interest within the world that the system needs to know about. Given these pieces of position information, images can be produced to present a stereo view of a virtual or modeled world or system that is oriented in a meaningful way based on the input of the viewing position. The stereo view is then presented to the viewer using a high-resolution display system, perhaps head mounted. The result is that one or more high precision streams of position data is input to the system to determine the viewing position and two high resolution image streams are output to present the stereo image.

The USB Type-C standard (USB-C) is currently the preferred cabling system for high bandwidth consumer applications. It contains 4 super-speed data transfer lanes, a “USB 2.0 High-Speed” (USB-HS) bus, and several other signals for dealing with power delivery and other overhead signaling. The super-speed lanes may be configured appropriately to the application, such as 2 bi-directional “USB 3.0 Super-Speed” (USB-SS) lanes or 4 uni-directional “Displayport over USB-C” lanes.

A system that delivers high resolution display image streams may consume all the super-speed data transfer lanes within the USB-C cable. The remaining data channel is the USB-HS bus, which has a theoretical maximum signaling rate of 480 Mbits/s. After accounting for bus overhead, the effective bandwidth is limited to about 280 Mbits/s.

A very precise position data stream may be accomplished with one or more cameras that can be used to image the world from the head's perspective, or the head from the world's perspective, as well as objects of interest from either perspective. A typical 8 MPixel camera with a 60 Hz frame rate produces data at a rate of nearly 4 Gbits/s. Increasing the frame rates makes the viewing position stream feedback smoother, but increases the bandwidth requirement even more. If more than one camera is used, then that also multiplies the bandwidth problem. For example, stereo 8 MPixel cameras at 120 Hz frame rate is nearly 16 Gbits/s.

At some point in the system, the viewing position information is transferred to the external processor responsible for image generation. The system designer has options in where to place the function that converts the raw position data stream into the viewing position information needed to generate the images. Typically, this positioning information is in the form of coordinates; such as X, Y, Z, Pitch, Yaw, and Roll relative to some common frame of reference, or the equivalent expressed in quaternion notation. This positioning information could indicate the position of the viewer, as well as positions of objects of interest. Typically, the conversion from the input imaging stream to the stream of positioning coordinates takes many steps. The remaining limited bandwidth available over USB-HS for the data stream over the USB-C cable suggests that some (or all) of the data reduction steps can be completed prior to sending data over the USB-HS link in order to fit the information into the limited bandwidth available for this stream.

It is an objective of the current invention to provide a process of converting raw high-precision positioning, or object recognition, data streams into useful information that can be transmitted at low data rates, such that both the high-resolution display image streams from mobile units and the data streams to mobile units can be accommodated in contemporary high-bandwidth signaling standards such as USB-C.

### BRIEF DESCRIPTION OF THE DRAWINGS

The foregoing summary, as well as the following detailed description of illustrative implementations, is better understood when read in conjunction with the appended drawings. For the purpose of illustrating the implementations, there is shown in the drawings example constructions of the implementations; however, the implementations are not limited to the specific methods and instrumentalities disclosed. In the drawings:

FIG. 1.—A typical configuration of an augmented reality HMD with mobile device interface

FIG. 2.—A block diagram of devices in the HMD

FIG. 3.—A flowchart of image processing and transfer

### DETAILED DESCRIPTION

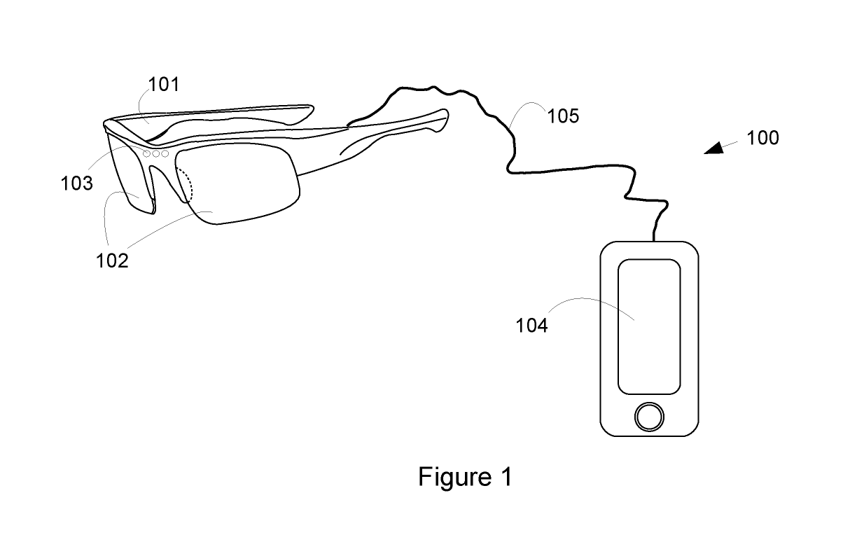

FIG. 1 shows a typical arrangement 100 in which a headset frame 101 is fitted with near eye see-through display lenses 102 and sensor elements 103 such as cameras, light level sensors, inertial measurement units, etc. to form an HMD for augmented reality viewing. This HMD is connected by high speed interface line 105 to the mobile device 104. The mobile device may be a smartphone and interface 105 may be a high speed data link such as, but not limited to, USB 2.0 or 3.0 associated with said smartphone. Those skilled in the art will understand that whereas link 105 is shown as a wired link, it may as well be a wireless link such as Bluetooth or various forms of WiFi.

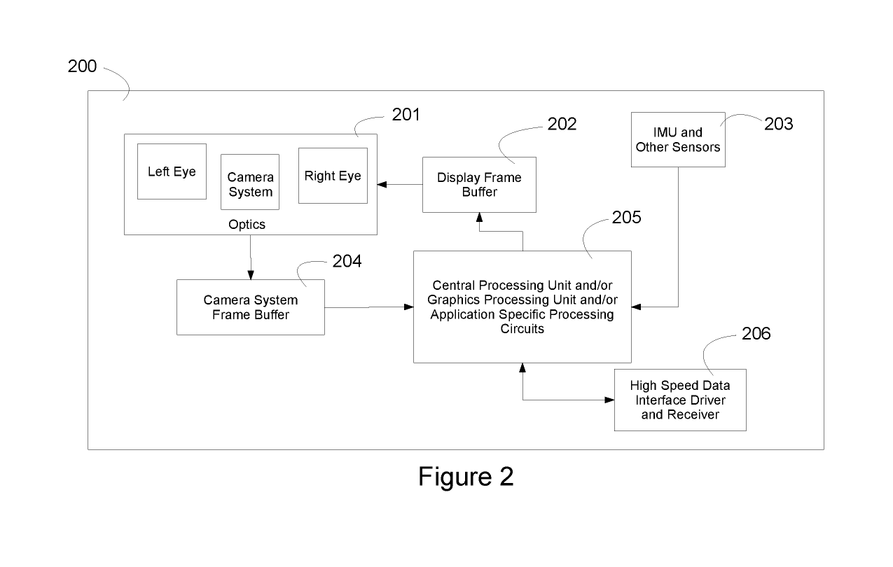

A block diagram decomposition of the HMD shown in FIG. 1 is shown as 200 in FIG. 2, while the device may further include components that are not illustrated in the drawing. Here the lenses 102 and camera(s) 103 are represented by boxes in the optics system 201. The displays are driven form the data loaded into the display frame buffer 202 which comes from a CPU/GPU/ASIC 205. In the other direction, images and data from the camera(s) and other optical sensors are transferred to the camera system frame buffer 204 which is then read and processed by 205. The system may include an inertial measurement unit 203 that also provides a plurality of sensor data for processing, and possible sensor fusion, by unit 205.

Central to the current invention is the high speed interface unit 206. This interface connects to the high speed data line 105 and transfers images and other data to and from the mobile data processing unit or smartphone 104. In general, the manufacturers of smartphones may envision optional connection to external display units, so the common interface unit will have that ability to send images outward from said phones. However, also in general the phones have internal high speed interfaces for their high resolution cameras that are built into those phones and do not have the capability to simultaneously output display images and input high resolution images from an external camera or cameras. It is an objective of the current invention to provide processing of image data by processor 205 such that compressed data of sufficient utility can be transferred by interface 206 to what may be a commercially available mobile unit 104.

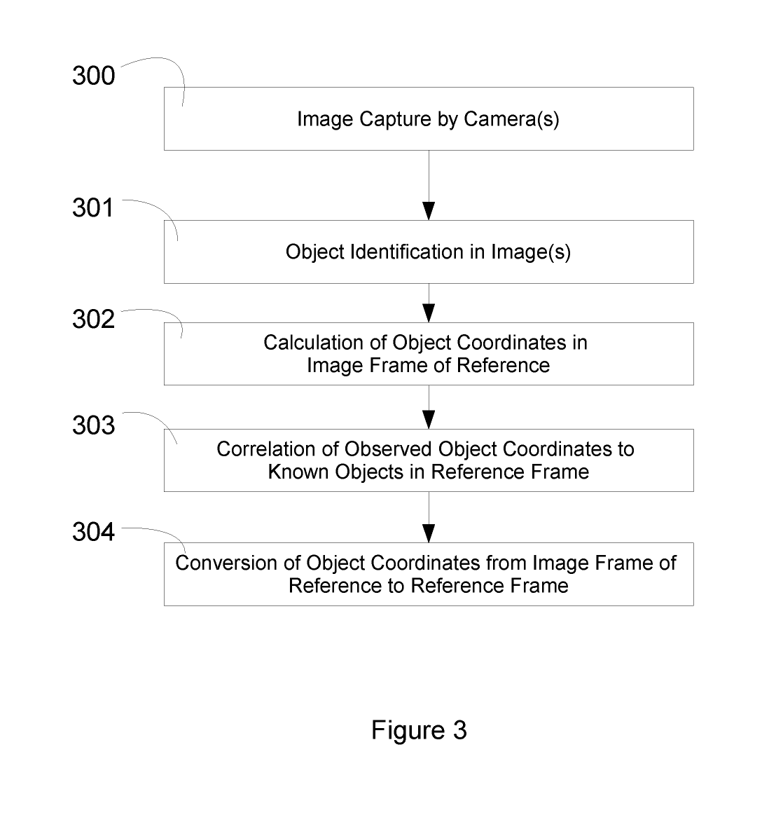

The processing steps used to generate the data sent to the external mobile unit are shown in FIG. 3. The operation of the current invention begins with the capture of images from the outside world as shown in step 300. As is known by those skilled in the art of machine vision, the processing unit(s) 205 are configured or otherwise programmed to identify objects 301 in said images. Having identified the object(s) of interest, coordinates are calculated with reference to the frame of the acquired image(s) 302. The observed object(s) coordinates are then correlated with those of known object in the reference frame 303. Finally, the correlated coordinates of the observed object(s) are converted from the image frame to the overall reference frame 304 before transmission to the external mobile unit.

The processing steps used to generate the data sent to the external mobile unit may also include sensor fusion steps, wherein data from an inertial measurement unit 203 is combined with object(s) of interest from identified in 301 to improve the calculated coordinates of the objects and HMD.

The system designer selects the partitioning of the system to pre-process the image stream before transmitting information over the data link 105. The trade-off is to get lower bandwidth by transmitting at a later part of the process at the cost of requiring more processing power prior to transmitting the information.

Whereas the embodiment herein has been described in view of a so called “near eye” HMD, it is generally also applicable to systems that employ head mounted projected displays such as disclosed by Ellsworth in US 2014/0340424 titled SYSTEM AND METHOD FOR RECONFIGURABLE PROJECTED AUGMENTED/VIRTUAL REALITY APPLIANCE.

### CONCLUSION

An illustrative embodiment has been described by way of example herein. While the embodiment shown is in the augmented reality art, those skilled in the art will understand, however, that it also applies directly to the virtual reality or mixed reality arts, and that changes and modifications may be made to this embodiment without departing from the true scope and spirit of the elements, products, and methods to which the embodiment is directed, which are defined by our claims.

That which is claimed:

1. A head mounted display system comprising:
a frame such as used for glasses for mounting to the head of a user;
one or more displays mounted in said frame for presentation of images to the eye or eyes of said user;
sensors also mounted in said frame to gather data from the environment of said user;
one or more computer data or graphics processing units mounted in said frame;
a high speed data interface capable of receiving image data from an external mobile computational unit, or smart phone, while simultaneously transferring a compressed form of said environmental data to said external mobile computational unit.

2. A head mounted display system according to claim 1 wherein said environmental data includes calculations of the position and/or pose of said head mounted display system.

3. A head mounted display system according to claim 1 wherein said environmental data includes calculated compressed numeric characterizations of images of external scenes or objects in view of image sensors mounted in said frame.

4. A method for the transfer of data to a mobile computation unit or smart phone comprising the steps:
presenting data from one or more cameras mounted in a head mounted display unit to a data computation and/or graphics computation unit also mounted in said head mounted display;
reducing the data rate needed to transfer the utility of the information in said data by calculating a numeric characterization of said camera data;
transferring said numeric characterization to an external mobile computing unit or smart phone while simultaneously receiving and displaying images from said external unit.

5. The method of claim 4 with the additional step of combining data from an internal inertial measurement, or similar internal sensors, and transferring said internal sensor data in said numeric characterization.
